(19) United States
(12) Patent Application Publication
(10) Pub. No.: US 2024/0273400 A1
(43) Pub. Date: Aug. 15, 2024

(54) HYPERPARAMETER TUNING

(71) Applicant: Microsoft Technology Licensing, LLC, Redmond, WA (US)

(72) Inventors: Laurent BOUÉ, Petah Tikva (IL); Kiran RAMA, Bangalore (IN)

(21) Appl. No.: 18/168,751

(22) Filed: Feb. 14, 2023

(51) Int. Cl. G06N 20/00

(52) U.S. Cl. CPC G06N 20/00

(57) ABSTRACT

A hyperparameter tuning system generates, for each hyperparameter, a performance attribution statistic corresponding to an evaluation metric of the machine learning model based on historical experiment statistics for the evaluation metric and the machine learning model. The hyperparameter tuning system allocates a weight to each hyperparameter based on the performance attribution statistic of the hyperparameter. The hyperparameter tuning system updates, in a series of experiments, the hyperparameters based on the weight assigned to each hyperparameter and selects a set of the hyperparameters for the machine learning model from one of the experiments, wherein the set of the hyperparameters results in a recorded value of the evaluation metric that satisfies a tuning condition.

### BACKGROUND

Generally, hyperparameters (e.g., relating to architectural complexity and algorithm hyperparameters) are adjustable parameters that influence the performance of a machine learning model. In contrast to internal parameters of a model, such as coefficients (or weights) of linear and logistic regression models, weights and biases of a neural network, and cluster centroids in clustering, which are trained during a training process, hyperparameters define structural and algorithmic characteristics of a machine learning model but are not trained during a machine learning training process. For example, a neural network designer decides the number of hidden layers and the number of nodes in each layer. For another example, XGBoost is an open-source software library that implements machine learning algorithms under the Gradient Boosting framework and can include a number of hyperparameters, such as the number of trees, the maximum depth of a tree, learning rate, regularization parameters, and the number of distinct classes for a classification problem. In various implementations, hyperparameters may be discrete and/or continuous and have a distribution of values described by a hyperparameter expression. The performance of a machine learning model depends heavily on its hyperparameters.

### SUMMARY

In some aspects, the techniques described herein relate to a method of tuning hyperparameters of a machine learning model, the method including: generating, for each hyperparameter, a performance attribution statistic corresponding to an evaluation metric of the machine learning model based on historical experiment statistics for the evaluation metric and the machine learning model; allocating a weight to each hyperparameter based on the performance attribution statistic of the hyperparameter; updating, in a series of experiments, the hyperparameters based on the weight assigned to each hyperparameter; and selecting a set of the hyperparameters for the machine learning model from one of the experiments, wherein the set of the hyperparameters results in a recorded value of the evaluation metric that satisfies a tuning condition.

In some aspects, the techniques described herein relate to a computing system for tuning hyperparameters of a machine learning model, the computing system including: one or more hardware processors; a performance attributor executable by the one or more hardware processors and configured to generate, for each hyperparameter, a performance attribution statistic corresponding to an evaluation metric of the machine learning model based on historical experiment statistics for the evaluation metric and the machine learning model; a hyperparameter weight assessor executable by the one or more hardware processors and configured to generate allocate a weight to each hyperparameter based on the performance attribution statistic of the hyperparameter; a hyperparameter updater executable by the one or more hardware processors and configured to update, in a series of experiments, the hyperparameters based on the weight assigned to each hyperparameter; and a hyperparameter selector executable by the one or more hardware processors and configured to select a set of the hyperparameters for the machine learning model from one of the experiments, wherein the set of the hyperparameters results in a recorded value of the evaluation metric that satisfies a tuning condition.

In some aspects, the techniques described herein relate to one or more tangible processor-readable storage media embodied with instructions for executing on one or more processors and circuits of a computing device a process of tuning hyperparameters of a machine learning model, the process including: generating, for each hyperparameter, a performance attribution statistic corresponding to an evaluation metric of the machine learning model based on historical experiment statistics for the evaluation metric and the machine learning model; allocating a weight to each hyperparameter based on the performance attribution statistic of the hyperparameter; updating, in a series of experiments, the hyperparameters based on the weight assigned to each hyperparameter; and selecting a set of the hyperparameters for the machine learning model from one of the experiments, wherein the set of the hyperparameters results in a recorded value of the evaluation metric that satisfies a tuning condition.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTION OF THE FIGURES

FIG. 1 illustrates an example system for tuning hyperparameters of a machine learning model.

FIG. 2 illustrates an example hyperparameter tuner system.

FIG. 3 illustrates example operations for tuning hyperparameters of a machine learning model.

FIG. 4 illustrates example operations for updating hyperparameters within a pre-designated compute budget.

FIG. 5 illustrates an example computing device for use in deferred formula computation.

### DETAILED DESCRIPTION

Hyperparameter tuning is a process of determining the configuration of hyperparameters that results in a desired level of performance (e.g., optimal performance). Different types of performance can be measured by evaluation metrics, such as one or more of accuracy, recall, specificity, sensitivity, F1 score, AUC-ROC, logarithmic loss, etc. This process can be computationally expensive and/or human-managed in some implementations, as it can involve exploring a large range of values defined for each hyperparameter (e.g., a grid search method) and human-selection of hyperparameters subsets (e.g., random selection/expert choice). Such example tuning processes are not generally coordinated with a compute budget (e.g., the amount of computing resources and/or the number of computing cycles allocated for the tuning, such as the number of experiments allotted) defined for the tuning objective.

In contrast, the described technology can provide technical benefits of reducing the computation expense and the need for manual intervention while coordinating with a designated compute budget to resolve quickly to a set of tuned hyperparameters. In one implementation, by using a database of historical experiment statistics of hyperparameters for a specific machine learning model type and applying a growth-rate-related criterion. for example, to these statistics, the described technology can identify initial values for each hyperparameter, determine the relative influence each individual hyperparameter has on a model's performance, and applies an appropriate weight to it. In this fashion, the allocation of the compute budget focuses on the more highly weighted hyperparameters to obtain a set of tuned hyperparameters.

Designing a machine learning model typically involves running many experiments with different outcomes from the machine learning model as it is being developed. An experiment tracking database includes historical experiment statistics relating to such previously executed experiments, such as how an evaluation metric changes relative to changes to different hyperparameters. Example experiments may evaluate, without limitation, different machine learning models, different model architectures, different hyperparameters, different training data, different evaluation metrics, different program code, and/or the same program code run in a different environment.

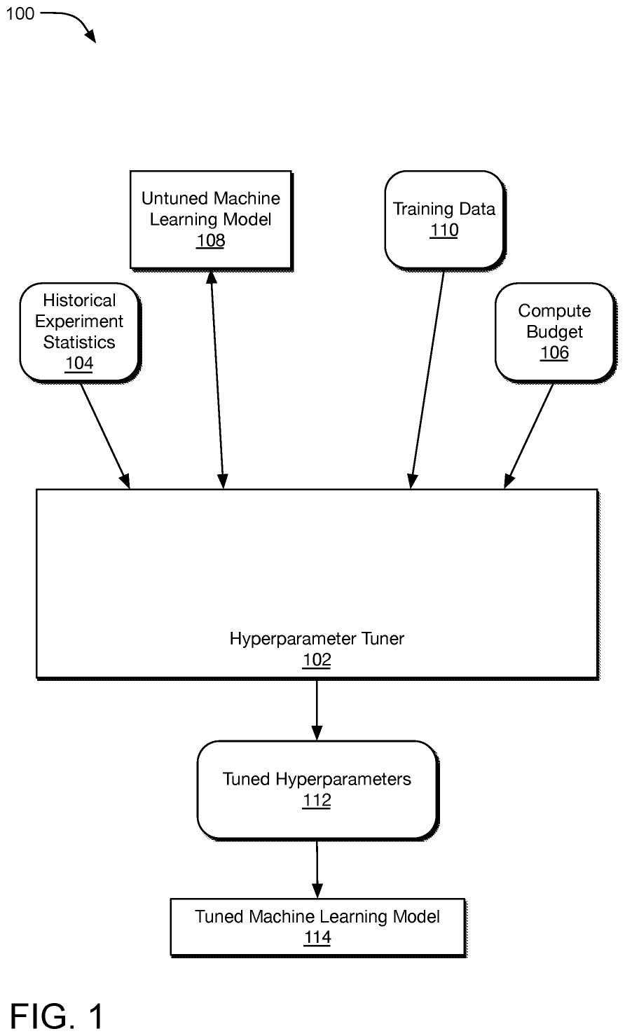

FIG. 1 illustrates an example system 100 for tuning hyperparameters of a machine learning model. Hyperparameters define the structural and algorithmic characteristics of a machine learning model but are not trained during a machine learning training process. Designing a machine learning model typically involves running different versions of a machine learning model (e.g., versions with different hyperparameters) with reference to one or more evaluation metrics. In this manner, historical values of the evaluation metric(s) are tracked against different values of each hyperparameter in a set of historical experiment statistics.

In various implementations, a hyperparameter tuner 102 receives a set of historical experiment statistics 104, which can be provided by an experiment tracking system that records machine learning experiments that have previously been executed on the machine learning model for a specified evaluation metric. The historical experiment statistics 104 can include data that characterizes the sensitivity of an evaluation metric to changes in various hyperparameters of the model. The hyperparameter tuner 102 also receives a compute budget 106, which defines or can be translated into a number of experiments that can be allocated to a given tuning session. For example, the compute budget 106 may allocate one hundred experiments for tuning the hyperparameters of the machine learning model.

In at least one implementation, the hyperparameter tuner 102 also receives an untuned machine learning model 108. For example, the hyperparameters of the untuned machine learning model 108 may be initialized with relevant but not tuned hyperparameter values that are to be updated to tuned hyperparameter values by the hyperparameter tuner 102. Initial versions of the hyperparameters can be generated using an experiment tracking database by setting each hyperparameter to the average of the values that are known to have led to the best value of the evaluation metric in previous experiments for the specific target machine learning model or model type, although other initialization operations may be employed. A purpose of this initialization step is to start off the hyperparameter search from good initial points, thereby accelerating the overall search time. The hyperparameter tuner 102 also receives training data 110 that can be used in the updating operations of the hyperparameter tuner 102 during tuning.

In the illustrated implementation, the hyperparameter tuner 102 includes one or more components that generate, for each hyperparameter, a performance attribution statistic corresponding to an evaluation metric of the machine learning model based on historical experiment statistics for the evaluation metric and the machine learning model. Other components allocate a weight to each hyperparameter based on the performance attribution statistic of the hyperparameter, update, in a series of experiments, the hyperparameters based on the weight assigned to each hyperparameter, and select a set of the hyperparameters for the machine learning model from one of the experiments. The selected set of the hyperparameters results in a recorded value of the evaluation metric that best satisfies a tuning condition, and this set of hyperparameters is output as the tuned hyperparameters 112, which can then be used to design a tuned machine learning model 114.

The hyperparameters may be tuned to a variety of evaluation metrics. For example, a tuning condition may be configured to determine whether the evaluation metric of “accuracy” of the machine learning model designed with a particular set of the hyperparameters results in the highest accuracy in the inference results of the machine learning model. Other tuning conditions may be configured to determine whether the evaluation metric of “specificity” of the machine learning model designed with a particular set of the hyperparameters results in the highest proportion of true negatives that are correctly predicted by the machine learning model or whether the evaluation metric of “sensitivity” of the machine learning model designed with a particular set of the hyperparameters results in the highest proportion of true positives that are correctly predicted by the machine learning model. Hyperparameters may be tuned to other evaluation metrics using the described technology.

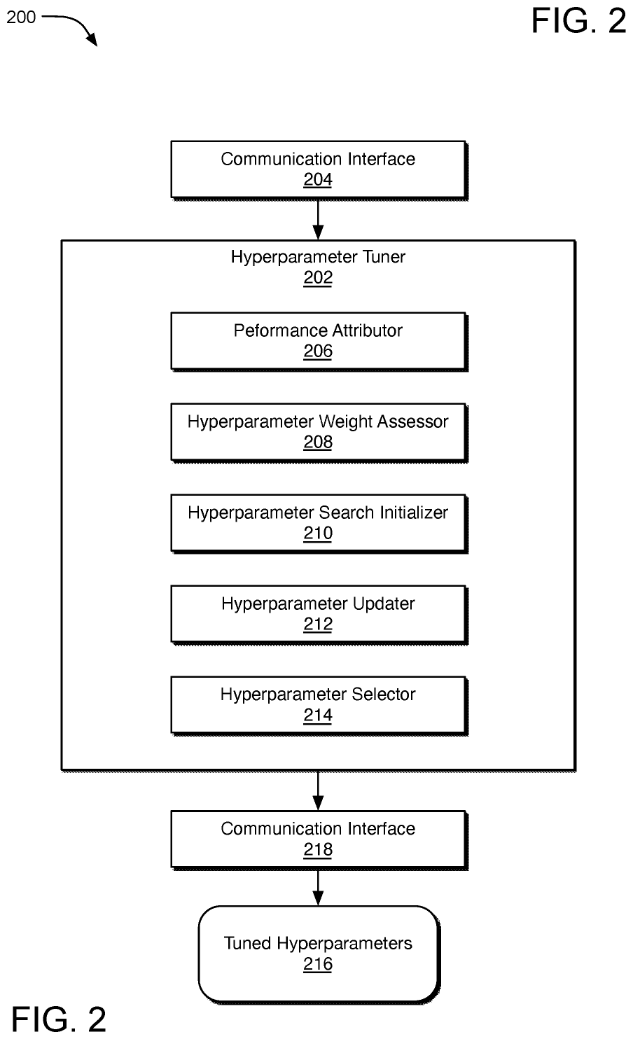

FIG. 2 illustrates an example hyperparameter tuner system 200. A hyperparameter tuner 202 includes various components that are configured to tune hyperparameters for a specified evaluation metric. The evaluation metric corresponds to a performance objective of the machine learning model to which the hyperparameters are being tuned.

A communication interface 204 receives inputs, such as the historical experiment statistics 104, the compute budget 106, the untuned machine learning model 108, and the training data 110 of FIG. 1, and passes the inputs to the hyperparameter tuner 202. The communication interface 204 may include software and/or circuitry and can be executable by one or more hardware processors of the hyperparameter tuner system 200.

A performance attributor 206 is executable by the one or more hardware processors of the hyperparameter tuner system 200 and is configured to generate a performance attribution statistic for each hyperparameter. Each performance attribution statistic corresponds to an evaluation metric of the machine learning model based on historical experiment statistics for the evaluation metric and the machine learning model, and the performance attribution statistic corresponding to the hyperparameter indicates a sensitivity of the evaluation metric to changes in the hyperparameter.

A hyperparameter weight assessor 208 is executable by the one or more hardware processors and is configured to allocate a weight to each hyperparameter based on the performance attribution statistic of the hyperparameter. The weight (wᵢ) of each hyperparameter is used to influence the selection of a hyperparameter for updating at each iteration. In one implementation, the hyperparameter to be updated in each iteration is selected randomly with a probability w′j. Accordingly, the hyperparameters with the higher weights have a higher likelihood of selection for updating in any particular iteration, thereby tending to result in a greater number of updating iterations on a more-heavily-weighted hyperparameter. Because the evaluation metric is known (based on the historical experiment statistics) to be more sensitive to changes in the more-heavily-weighted hyperparameters, the hyperparameter tuner system 200 focuses on updating those hyperparameters as compared to the less-heavily-weighted hyperparameters, making better use of the available compute budget.

A hyperparameter search initializer 210 initializes the weights of the hyperparameters in an untuned version of the machine learning model. Initial versions of the hyperparameters can be generated using the experiment tracking database by setting each hyperparameter to the average of the values that are known to have led to the best value of the evaluation metric in previous experiments for the machine learning model, although other initialization operations may be employed. A purpose of this initialization step is to start off the hyperparameter search from good initial values, thereby accelerating the overall search time. In other implementations, the untuned version of the machine learning model may be initialized prior to input to the hyperparameter tuner 202.

A hyperparameter updater 212 is executable by the one or more hardware processors and is configured to update, in a series of experiments, the hyperparameters based on the weight assigned to each hyperparameter. In one implementation, the hyperparameter updater 212 performs updates for multiple iterations (e.g., one experiment per iteration) limited by the compute budget by selecting a hyperparameter based on the weight allocated to the hyperparameter, updating the hyperparameter to a new value, executing an experiment on the machine learning model based on the new value of the hyperparameter, and recording a value of the evaluation metric resulting from the experiment. Various updating methods may be employed. In one implementation, using a Bayesian update method, the hyperparameter updater 212 updates the hyperparameter to a new value based on maximizing a growth rate of the evaluation metric based on changes in the hyperparameter and minimizing a covariance of the evaluation metric based on changes in the hyperparameter.

A hyperparameter selector 214 is executable by the one or more hardware processors and is configured to select a set of the hyperparameters for the machine learning model from one of the experiments, wherein the set of the hyperparameters results in a recorded value of the evaluation metric that satisfies a tuning condition.

The selected set of hyperparameters is output as tuned hyperparameters 216 via a communication interface 218 (which may be the same interface as communication interface 204). The tuned hyperparameters 216 can then be used to complete the design of a tuned machine learning model. For example, if one of the tuned hyperparameters is the number of layers in a neural network, then the tuned machine learning model is generated with the tuned number of layers.

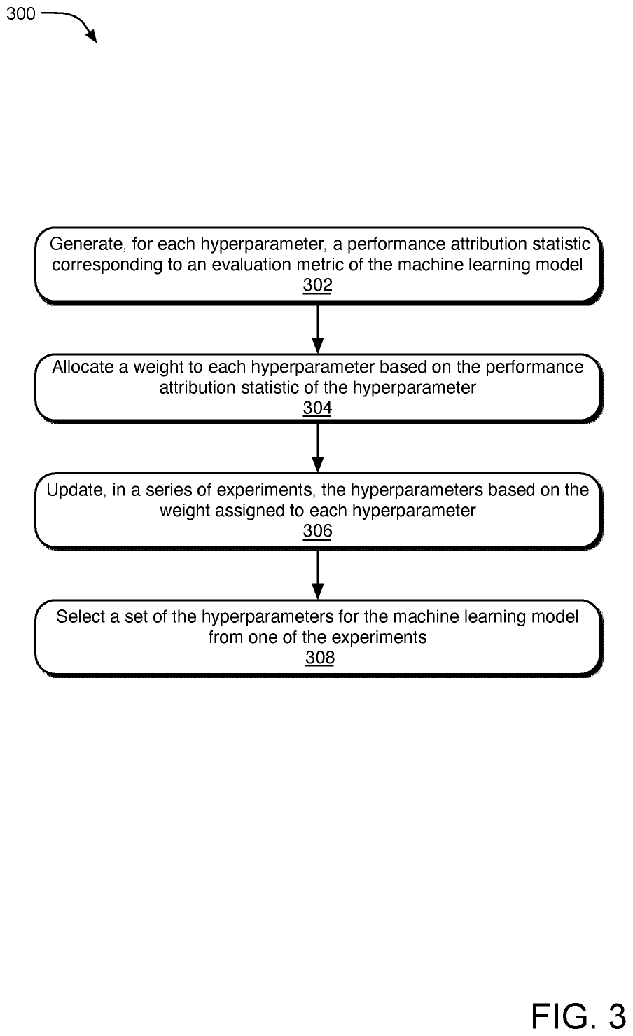

FIG. 3 illustrates example operations 300 for tuning hyperparameters of a machine learning model. A generating operation 302 generates a performance attribution statistic for each hyperparameter as it relates to an evaluation metric of the machine learning model (e.g., performance, classification accuracy, logarithmic loss, confusion matrix). A performance attribution statistic corresponding to a hyperparameter indicates a sensitivity of the evaluation metric to changes in the hyperparameter. In some implementations, the performance metric statistics from historical experiments are tracked in an experiment tracking database. These statistics are filtered down to include those records that are relevant for the particular machine learning algorithm and evaluation metric for which the hyperparameters are being tuned. For example, the tracked statistics can be filtered to include only those statistics relating to accuracy.

The terms MI, model and evaluationMetric refer to the machine learning model and the performance objective, respectively, for which the hyperparameters are to be tuned. By fixing ML_model and evaluationMetric to selected values, the filtered statistics can be stored in a file with an example schema that follows, although other schemas may be employed:

$${h}_{1} , … , {h}_{N h} , valueOfEvaluationMetric$$

where Nh represents the number of hyperparameters included in the experiments.

Rows in this file correspond to different experiments that have been previously executed based on the historical values of all the hyperparameters, as well as the value of the evaluation metric that the target machine learning model is trying to optimize. This file defines the performance attribution statistics dataset. A subsequent step includes building a prediction-family machine learning model tasked with predicting the value of the evaluation metric using the hyperparameters' values as features. The performance attribution dataset can be split into a training subset and a test subset. Once the machine learning model has been trained using the training subset, the test subset is applied to the machine learning model along with a local interpretability framework (such as LIME or SHAP) to give each hyperparameter a score indicative of how much each hyperparameter contributes to the performance attribution model's predictions. Hyperparameters with positive scores can be considered “high performers,” whereas those with negative scores tend to drag the performance lower. By extension, hyperparameters with scores close to zero do not participate in any significant manner to the overall performance. Eventually, scores for each of the hyperparameters are obtained, as shown in the example schema below:

$$( 1 st test sample ) {h}_{1 \_ 1 \_ score} , … , {h}_{1 \_ Nh \_ score}$$

$$…$$

$$( last test sample ) {h}_{Ntest \_ 1 \_ score} , … , {h}_{Ntest \_ Nh \_ score}$$

where Ntest represents the number of experiments recorded in the file.

This data is used to compute the following historical performance of each hyperparameter:

Mean scores

$${m}_{1} ( {h}_{1 \_ 1 \_ score} + … + {h}_{Ntest \_ 1 \_ score} ) / Ntest$$

$$…$$

$${m}_{Nh} ( {h}_{1 \_ Nh \_ score} + … + {h}_{Ntest \_ Nh \_ score} ) / Ntest$$

### Covariance Coefficient Between all Pairs (i, j) of Hyperparameters

$${sigma}_{ij} = [ \text{} ( {h}_{1 \_ 1 \_ score} - {m}_{i} ) ( {h}_{1 \_ i} - {m}_{j} ) + … + ( {m}_{Ntest \_ i} - {m}_{i} ) ( {m}_{Ntest \_ j} - {m}_{j} ) ] \text{} / ( 2 \cdot Ntes {t}^{2} )$$

An allocation operation 304 allocates a weight to each hyperparameter based on the performance attribution statistic of the hyperparameter. In various implementations, one or more sensitivity criteria are applied to each hyperparameter to assign each hyperparameter a weight that incorporates the sensitivity of the evaluation metric to changes in the hyperparameter. Such a criterion can be used to maximize the expected growth rate and the median terminal value of the evaluation metric of the machine learning model. In one example, a Kelly criterion (e.g., yielding Kelly fractions or weights) is applied to determine such weights, although other criteria may be applied. The weights are denoted herein as W={w₁, . . . , w_{Nh}}, the set of weights allocated to each parameter, wherein the sum of the weights is normalized to one in at least one implementation.

In one implementation, the following example criterion objective (“Obj”) is employed:

$$Obj = {argmax}_{W} [ \text{} \sum ( {w}_{i} \cdot {m}_{i} , \{ i , 1 , n \} ) - 0.5 \cdot \sum ( {w}_{i} \cdot {w}_{j} \cdot {sigma}_{i j} , \{ i , 1 , n \} , \{ j , 1 , n \} ) ] ,$$

such that w₁+ . . . , w_{Nh}=1. The argmax_{w} symbol represents a search for values of W, such that the expression inside the square brackets is maximized:

1. The first term inside the square brackets attempts to maximize the total expected improvement in the evaluation metric— multiply the mean performance mi of a hyperparameter with its allocated weight wᵢ and sum this product over all hyperparameters.

2. The second term tries to minimize the total covariance that quantifies the level of risk/volatility of the evaluation metric— multiple each covariance component sigmaᵢⱼ for hyperparameters i and j with their allocated weights wᵢ and wⱼ and sum this product over all pairs of hyperparameters. The sum of the allocated weights equals one.

Generally, the criterion objective problem can be solved using a numerical solver for (constrained) quadratic optimization. In some implementations, the criterion objective problem can be solved exactly in the case that there are no correlations between any of the hyperparameters, such that optimal weights are given by:

$${w}_{i} = \frac{{m}_{i}}{{sigma}_{i}^{2}}$$

wherein sigma; is the standard deviation of the scores mi. A result of the quadratic solver includes a set of weights W={w₁, . . . , w_{Nh}} associated with the Nh hyperparameters.

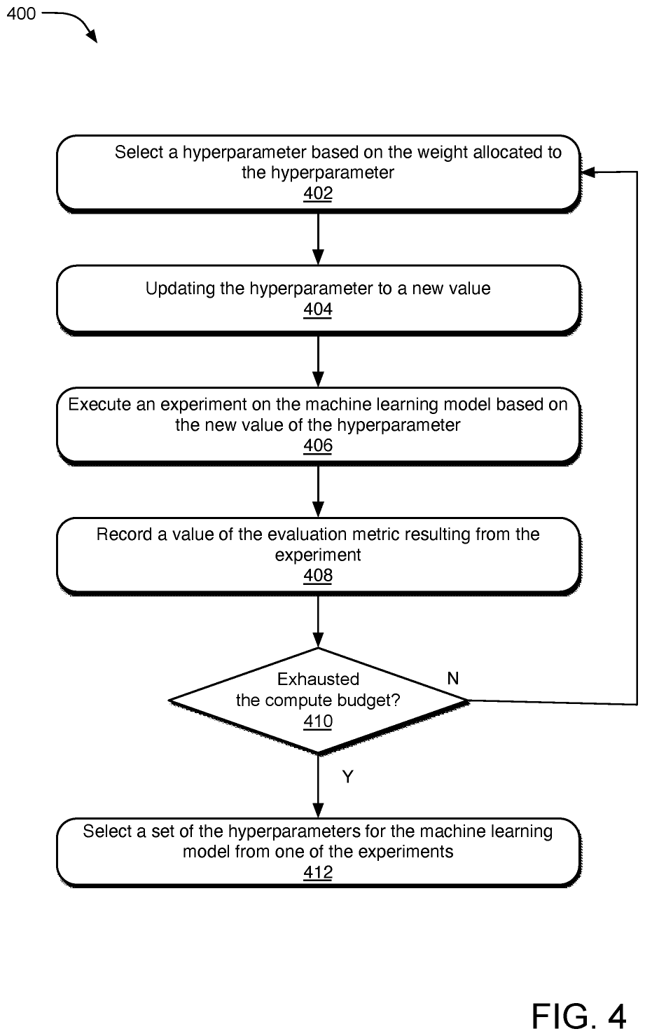

An updating operation 306 updates each hyperparameter using a hyperparameter tuning model based on the weight allocated to the hyperparameter. An example hyperparameter updating process is described in more detail with respect to FIG. 4. A selecting operation 308 selects a set of the hyperparameters for the machine learning model from one of the experiments, wherein the set of the hyperparameters results in a recorded value of the evaluation metric that satisfies a tuning condition.

FIG. 4 illustrates example operations 400 for updating hyperparameters within a pre-designated compute budget. Initial versions of the Nh hyperparameters are generated using an experiment tracking database by setting each hyperparameter to the average of the values that are known to have led to the best value of the evaluation metric (for that specific target machine learning model). A purpose of this initialization step is to start off the hyperparameter search from good initial points, thereby accelerating the overall search time. The number of experiments available for this hyperparameter tuning session is set by a compute budget parameter, N_{budget}, so such initialization can reduce the number of experiments needed to obtain effective tuning.

For each experiment, a selection operation 402 selects hyperparameter Nᵢ randomly with a probability wᵢ, obtained from a weight allocation process. In this matter, the hyperparameters to which the evaluation metric is most sensitive— those having a higher weight— have a higher probability of being selected and updated in each experiment. Accordingly, the more highly weighted hyperparameters will typically be updated more times than lower weighted hyperparameters.

Thereafter, an updating operation 404 updates the value of each hyperparameter, h, using an updating model, such as a dedicated Bayesian model bᵢ for each hyperparameter. In one example of an update model, Bayes' theorem can be used to update hyperparameters. Note that, in at least some implementations, each hyperparameter is assigned its own Bayesian model, so a database B={b₁, . . . , b_{Nh}} models is employed.

Generally, the concept of a Bayesian update is that the choice of hyperparameters to be used in an experiment is decided in an informed matter that takes into account past experiences. In one implementation, Bayesian updating is used as an efficient method of converging to a tuned (e.g., optimal) value of the evaluation metric by changing the values of the hyperparameters in different experiments (e.g., iterations). Each iteration of the Bayesian updating provides a new value of a hyperparameter to test against its impact on the evaluation metric.

Bayess' Theorem is given by

$$P ( H \vert D ) = \frac{P ( H ) P ( D \vert H )}{P ( D )}$$

wherein P(H) is the probability of a hypothesis, which is the “prior”— how likely it is that the hypothesis is correct without knowledge of any evidence; P(D|H) is the likelihood, which is the probability of the known evidence being correct given the hypothesis; P(H|D) is the probability that the evidence is correct given the hypothesis; and P(D) is the probability of the evidence, which is the sum of the product of the likelihoods and the prior:

$$P ( D ) = {\sum }_{n} P ( {H}_{n} ) P ( D \vert {H}_{n} )$$

Accordingly, Bayesian updating can be used to update a hypothesis (e.g., the value of a hyperparameter to be used in the next experiment) when new data is available (e.g., the value of the evaluation metric from a previous experiment). For example, given data D as the evidence, such that a data point dᵢ ∈D is a value of an evaluation metric from an experiment i, then the posterior is:

$$P ( H \vert {d}_{1} ) = \frac{P ( H ) P ( {d}_{1} \vert H )}{P ( {d}_{1} )} .$$

Given another data point d₂ (e.g., a value of an evaluation metric from a second experiment), the posterior can be updated in a subsequent iteration, with the prior in this iteration being the posterior in the previous iteration:

$$P ( H ) = P ( H \vert {d}_{1} )$$

This manner of updating can propagate through multiple iterations of updating within the compute budget.

An experimenting operation 406 executes an experiment on the machine learning model based on the updated value of the hyperparameter. For example, the experimenting operation 406 executes the machine learning model with the updated hyperparameter on a set of training data, resulting in an evaluation metric (e.g., a resulting accuracy metric, a resulting specificity metric) for that experiment iteration.

A recording operation 408 records a value of the evaluation metric resulting from the experiment in association with the hyperparameter set used in the corresponding experiment. For example, after each experiment completes, the results of the experiment are stored in a file with a schema, such as the following schema:

$${h}_{1 \_ ( trial = 1 )} , … , {h}_{Nh \_ ( trial = 1 )} , valueOfEvaluationMetric$$

$$…$$

$${h}_{1 \_ ( trial = t )} , … , {h}_{Nh \_ ( trial = t )} , valueOfEvaluationMetric$$

A decision operation 410 determines whether the number of experiments in this tuning session has met the compute budget. If not, another experiment is executed, starting with the selection operation 402 to continue the series of experiments. In the alternative, after all experiments have been executed (e.g., exhausting the compute budget), another selection operation 412 selects the hyperparameters associated with the best value OfEvaluationMetric (e.g., the value that best satisfies the tuning condition) are selected and assigned to the machine learning model to yield a tuned machine learning model.

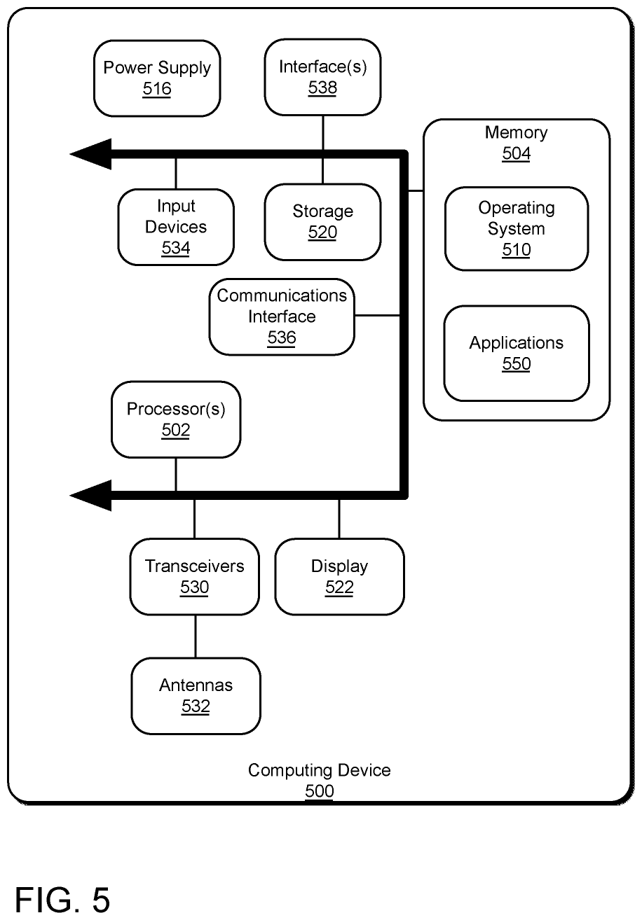

FIG. 5 illustrates an example computing device 500 for use in deferred formula computation. The computing device 500 may be a client device, such as a laptop, mobile device, desktop, tablet, or a server/cloud device. The computing device 500 includes one or more processor(s) 502, and a memory 504. The memory 504 generally includes both volatile memory (e.g., RAM) and nonvolatile memory (e.g., flash memory). An operating system 510 resides in the memory 504 and is executed by the processor(s) 502.

In the example computing device 500, as shown in FIG. 5, one or more modules or segments, such as applications 550, a communication interface, a performance attributor, a hyperparameter weight assessor, a hyperparameter search initializer, a hyperparameter updater, a hyperparameter selector, and other program code and modules are loaded into the operating system 510 on the memory 504 and/or storage 520 and executed by processor(s) 502. The storage 520 may store historical experiment statistics training data, a compute budget, evaluation metrics, hyperparameters, and other data and be local to the computing device 500 or may be remote and communicatively connected to the computing device 500. In particular, in one implementation, components of hyperparameter tuner system may be implemented entirely in hardware or in a combination of hardware circuitry and software.

The computing device 500 includes a power supply 516, which is powered by one or more batteries or other power sources, and which provides power to other components of the computing device 500. The power supply 516 may also be connected to an external power source that overrides or recharges the built-in batteries or other power sources.

The computing device 500 may include one or more communication transceivers 530, which may be connected to one or more antenna(s) 532 to provide network connectivity (e.g., mobile phone network, Wi-Fi®, Bluetooth®) to one or more other servers and/or client devices (e.g., mobile devices, desktop computers, or laptop computers). The computing device 500 may further include a communications interface 536 (such as a network adapter or an I/O port, which are types of communication devices). The computing device 500 may use the adapter and any other types of communication devices for establishing connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard or mouse). These and other input devices may be coupled to the server by one or more interfaces 538, such as a serial port interface, parallel port, or universal serial bus (USB). The computing device 500 may further include a display 522, such as a touchscreen display.

The computing device 500 may include a variety of tangible processor-readable storage media and intangible processor-readable communication signals. Tangible processor-readable storage can be embodied by any available media that can be accessed by the computing device 500 and can include both volatile and nonvolatile storage media and removable and non-removable storage media. Tangible processor-readable storage media excludes intangible communications signals (such as signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of tuning hyperparameters of a machine learning model, the method comprising: generating, for each hyperparameter, a performance attribution statistic corresponding to an evaluation metric of the machine learning model based on historical experiment statistics for the evaluation metric and the machine learning model; allocating a weight to each hyperparameter based on the performance attribution statistic of the hyperparameter; updating, in a series of experiments, the hyperparameters based on the weight assigned to each hyperparameter; and selecting a set of the hyperparameters for the machine learning model from one of the experiments, wherein the set of the hyperparameters results in a recorded value of the evaluation metric that satisfies a tuning condition.

Clause 2. The method of clause 1, wherein the evaluation metric corresponds to a performance objective of the machine learning model to which the hyperparameters are being tuned.

Clause 3. The method of clause 1, wherein the historical experiment statistics track historical values of the evaluation metric against different values of each hyperparameter.

Clause 4. The method of clause 1, wherein the performance attribution statistic corresponding to the hyperparameter indicates a sensitivity of the evaluation metric to changes in the hyperparameter.

Clause 5. The method of clause 1, wherein the updating comprises: for multiple iterations limited by a compute budget, selecting a hyperparameter based on the weight allocated to the hyperparameter, updating the hyperparameter to a new value, executing an experiment on the machine learning model based on the new value of the hyperparameter, and recording a value of the evaluation metric resulting from the experiment.

Clause 6. The method of clause 1, wherein the updating comprises: updating the hyperparameter to a new value based on maximizing a growth rate of the evaluation metric based on changes in the hyperparameter and minimizing a covariance of the evaluation metric based on changes in the hyperparameter.

Clause 7. The method of clause 1, wherein the updating comprises: updating the hyperparameter to a new value using a Bayesian model.

Clause 8. A computing system for tuning hyperparameters of a machine learning model, the computing system comprising: one or more hardware processors; a performance attributor executable by the one or more hardware processors and configured to generate, for each hyperparameter, a performance attribution statistic corresponding to an evaluation metric of the machine learning model based on historical experiment statistics for the evaluation metric and the machine learning model; a hyperparameter weight assessor executable by the one or more hardware processors and configured to allocate a weight to each hyperparameter based on the performance attribution statistic of the hyperparameter; a hyperparameter updater executable by the one or more hardware processors and configured to update, in a series of experiments, the hyperparameters based on the weight assigned to each hyperparameter; and a hyperparameter selector executable by the one or more hardware processors and configured to select a set of the hyperparameters for the machine learning model from one of the experiments, wherein the set of the hyperparameters results in a recorded value of the evaluation metric that satisfies a tuning condition.

Clause 9. The computing system of clause 8, wherein the evaluation metric corresponds to a performance objective of the machine learning model to which the hyperparameters are being tuned.

Clause 10. The computing system of clause 8, wherein the historical experiment statistics track historical values of the evaluation metric against different values of each hyperparameter.

Clause 11. The computing system of clause 8, wherein the performance attribution statistic corresponding to the hyperparameter indicates a sensitivity of the evaluation metric to changes in the hyperparameter.

Clause 12. The computing system of clause 8, wherein, for multiple iterations limited by a compute budget, the hyperparameter updater is further configured to: randomly select a hyperparameter based on the weight allocated to the hyperparameter, update the hyperparameter to a new value, execute an experiment on the machine learning model based on the new value of the hyperparameter, and record a value of the evaluation metric resulting from the experiment.

Clause 13. The computing system of clause 8, wherein the hyperparameter updater is further configured to update the hyperparameter to a new value based on maximizing a growth rate of the evaluation metric based on changes in the hyperparameter and minimizing a covariance of the evaluation metric based on changes in the hyperparameter.

Clause 14. The computing system of clause 8, wherein the hyperparameter updater is further configured to update the hyperparameter to a new value using a Bayesian model.

Clause 15. One or more tangible processor-readable storage media embodied with instructions for executing on one or more processors and circuits of a computing device a process of tuning hyperparameters of a machine learning model, the process comprising: generating, for each hyperparameter, a performance attribution statistic corresponding to an evaluation metric of the machine learning model based on historical experiment statistics for the evaluation metric and the machine learning model; allocating a weight to each hyperparameter based on the performance attribution statistic of the hyperparameter; updating, in a series of experiments, the hyperparameters based on the weight assigned to each hyperparameter; and selecting a set of the hyperparameters for the machine learning model from one of the experiments, wherein the set of the hyperparameters results in a recorded value of the evaluation metric that satisfies a tuning condition.

Clause 16. The one or more tangible processor-readable storage media of clause 15, wherein the evaluation metric corresponds to a performance objective of the machine learning model to which the hyperparameters are being tuned.

Clause 17. The one or more tangible processor-readable storage media of clause 15, wherein the historical experiment statistics track historical values of the evaluation metric against different values of each hyperparameter.

Clause 18. The one or more tangible processor-readable storage media of clause 15, wherein the performance attribution statistic corresponding to the hyperparameter indicates a sensitivity of the evaluation metric to changes in the hyperparameter.

Clause 19. The one or more tangible processor-readable storage media of clause 15, wherein the updating comprises: for multiple iterations limited by a compute budget, selecting a hyperparameter based on the weight allocated to the hyperparameter, updating the hyperparameter to a new value, executing an experiment on the machine learning model based on the new value of the hyperparameter, and recording a value of the evaluation metric resulting from the experiment.

Clause 20. The one or more tangible processor-readable storage media of clause 15, wherein the updating comprises: updating the hyperparameter to a new value based on maximizing a growth rate of the evaluation metric based on changes in the hyperparameter and minimizing a covariance of the evaluation metric based on changes in the hyperparameter.

Clause 21. A system for tuning hyperparameters of a machine learning model, the system comprising: means for generating, for each hyperparameter, a performance attribution statistic corresponding to an evaluation metric of the machine learning model based on historical experiment statistics for the evaluation metric and the machine learning model; means for allocating a weight to each hyperparameter based on the performance attribution statistic of the hyperparameter; means for updating, in a series of experiments, the hyperparameters based on the weight assigned to each hyperparameter; and means for selecting a set of the hyperparameters for the machine learning model from one of the experiments, wherein the set of the hyperparameters results in a recorded value of the evaluation metric that satisfies a tuning condition.

Clause 22. The system of clause 21, wherein the evaluation metric corresponds to a performance objective of the machine learning model to which the hyperparameters are being tuned.

Clause 23. The system of clause 21, wherein the historical experiment statistics track historical values of the evaluation metric against different values of each hyperparameter.

Clause 24. The system of clause 21, wherein the performance attribution statistic corresponding to the hyperparameter indicates a sensitivity of the evaluation metric to changes in the hyperparameter.

Clause 25. The system of clause 21, wherein the means for updating comprises: for multiple iterations limited by a compute budget, means for selecting a hyperparameter based on the weight allocated to the hyperparameter, means for updating the hyperparameter to a new value, means for executing an experiment on the machine learning model based on the new value of the hyperparameter, and means for recording a value of the evaluation metric resulting from the experiment.

Clause 26. The system of clause 21, wherein the means for updating comprises: means for updating the hyperparameter to a new value based on maximizing a growth rate of the evaluation metric based on changes in the hyperparameter and minimizing a covariance of the evaluation metric based on changes in the hyperparameter.

Clause 27. The system of clause 21, wherein the updating comprises: means for updating the hyperparameter to a new value using a Bayesian model.

Some implementations may comprise an article of manufacture. An article of manufacture may comprise a tangible storage medium to store logic. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of tuning hyperparameters of a machine learning model, the method comprising:
generating, for each hyperparameter, a performance attribution statistic corresponding to an evaluation metric of the machine learning model based on historical experiment statistics for the evaluation metric and the machine learning model;
allocating a weight to each hyperparameter based on the performance attribution statistic of the hyperparameter;
updating, in a series of experiments, the hyperparameters based on the weight assigned to each hyperparameter; and
selecting a set of the hyperparameters for the machine learning model from one of the experiments, wherein the set of the hyperparameters results in a recorded value of the evaluation metric that satisfies a tuning condition.

2. The method of claim 1, wherein the evaluation metric corresponds to a performance objective of the machine learning model to which the hyperparameters are being tuned.

3. The method of claim 1, wherein the historical experiment statistics track historical values of the evaluation metric against different values of each hyperparameter.

4. The method of claim 1, wherein the performance attribution statistic corresponding to the hyperparameter indicates a sensitivity of the evaluation metric to changes in the hyperparameter.

5. The method of claim 1, wherein the updating comprises:
for multiple iterations limited by a compute budget,
selecting a hyperparameter based on the weight allocated to the hyperparameter,
updating the hyperparameter to a new value,
executing an experiment on the machine learning model based on the new value of the hyperparameter, and
recording a value of the evaluation metric resulting from the experiment.

6. The method of claim 1, wherein the updating comprises:
updating the hyperparameter to a new value based on maximizing a growth rate of the evaluation metric based on changes in the hyperparameter and minimizing a covariance of the evaluation metric based on changes in the hyperparameter.

7. The method of claim 1, wherein the updating comprises:
updating the hyperparameter to a new value using a Bayesian model.

8. A computing system for tuning hyperparameters of a machine learning model, the computing system comprising:
one or more hardware processors;
a performance attributor executable by the one or more hardware processors and configured to generate, for each hyperparameter, a performance attribution statistic corresponding to an evaluation metric of the machine learning model based on historical experiment statistics for the evaluation metric and the machine learning model;
a hyperparameter weight assessor executable by the one or more hardware processors and configured to allocate a weight to each hyperparameter based on the performance attribution statistic of the hyperparameter;
a hyperparameter updater executable by the one or more hardware processors and configured to update, in a series of experiments, the hyperparameters based on the weight assigned to each hyperparameter; and
a hyperparameter selector executable by the one or more hardware processors and configured to select a set of the hyperparameters for the machine learning model from one of the experiments, wherein the set of the hyperparameters results in a recorded value of the evaluation metric that satisfies a tuning condition.

9. The computing system of claim 8, wherein the evaluation metric corresponds to a performance objective of the machine learning model to which the hyperparameters are being tuned.

10. The computing system of claim 8, wherein the historical experiment statistics track historical values of the evaluation metric against different values of each hyperparameter.

11. The computing system of claim 8, wherein the performance attribution statistic corresponding to the hyperparameter indicates a sensitivity of the evaluation metric to changes in the hyperparameter.

12. The computing system of claim 8, wherein, for multiple iterations limited by a compute budget, the hyperparameter updater is further configured to:
randomly select a hyperparameter based on the weight allocated to the hyperparameter,
update the hyperparameter to a new value,
execute an experiment on the machine learning model based on the new value of the hyperparameter, and
record a value of the evaluation metric resulting from the experiment.

13. The computing system of claim 8, wherein the hyperparameter updater is further configured to update the hyperparameter to a new value based on maximizing a growth rate of the evaluation metric based on changes in the hyperparameter and minimizing a covariance of the evaluation metric based on changes in the hyperparameter.

14. The computing system of claim 8, wherein the hyperparameter updater is further configured to update the hyperparameter to a new value using a Bayesian model.

15. One or more tangible processor-readable storage media embodied with instructions for executing on one or more processors and circuits of a computing device a process of tuning hyperparameters of a machine learning model, the process comprising:
generating, for each hyperparameter, a performance attribution statistic corresponding to an evaluation metric of the machine learning model based on historical experiment statistics for the evaluation metric and the machine learning model;
allocating a weight to each hyperparameter based on the performance attribution statistic of the hyperparameter;
updating, in a series of experiments, the hyperparameters based on the weight assigned to each hyperparameter; and
selecting a set of the hyperparameters for the machine learning model from one of the experiments, wherein the set of the hyperparameters results in a recorded value of the evaluation metric that satisfies a tuning condition.

16. The one or more tangible processor-readable storage media of claim 15, wherein the evaluation metric corresponds to a performance objective of the machine learning model to which the hyperparameters are being tuned.

17. The one or more tangible processor-readable storage media of claim 15, wherein the historical experiment statistics track historical values of the evaluation metric against different values of each hyperparameter.

18. The one or more tangible processor-readable storage media of claim 15, wherein the performance attribution statistic corresponding to the hyperparameter indicates a sensitivity of the evaluation metric to changes in the hyperparameter.

19. The one or more tangible processor-readable storage media of claim 15, wherein the updating comprises:
for multiple iterations limited by a compute budget,
selecting a hyperparameter based on the weight allocated to the hyperparameter,
updating the hyperparameter to a new value,
executing an experiment on the machine learning model based on the new value of the hyperparameter, and
recording a value of the evaluation metric resulting from the experiment.

20. The one or more tangible processor-readable storage media of claim 15, wherein the updating comprises:
updating the hyperparameter to a new value based on maximizing a growth rate of the evaluation metric based on changes in the hyperparameter and minimizing a covariance of the evaluation metric based on changes in the hyperparameter.
